(19) United States
(12) Patent Application Publication
(10) Pub. No.: US 2015/0178022 A1
(43) Pub. Date: Jun. 25, 2015

(54) Methods for Optimizing Load Density in a Managed Asset Environment

(71) Applicant: Lexmark International, Inc., Lexington, KY (US)

(72) Inventors: Joseph Andrew Alkuino de la Peña, Cebu (PH); Theresa Cabahag Maxino, Cebu City (PH); Kareen Dayonot Tariman, Cebu City (PH); Tristan Santos Dalay, Mandaue City (PH)

(73) Assignee: Lexmark International, Inc., Lexington, KY (US)

(21) Appl. No.: 14/135,975

(22) Filed: Dec. 20, 2013

(51) Int. Cl. G06F 3/12

(52) U.S. Cl. CPC G06F 3/126; G06F 3/122; G06F 3/1224; G06F 3/1291

(57) ABSTRACT

A computing device hosts an optimization application for optimizing a managed asset environment. The environment includes a plurality of electronic devices in a plurality of regions that subdivide the environment. Usage information associated with electronic devices per region is generated. Based on the usage information, a determination is made whether load density per region exceeds a value of a predetermined metric. Upon determining that a load density of at least one region exceeds the value, the application provides an indication to adjust a number of electronic devices in one or more of the regions to cause the load density of the at least one region to be less than the value and thereby substantially balance the load density between the plurality of regions. The indication is provided as an optimized map reflecting changes or adjustments in electronic devices and their locations.

### FIELD OF THE INVENTION

The present invention relates to asset management. More particularly, it relates to optimizing load density in a managed asset environment, such as an imaging environment having a plurality of imaging devices.

### BACKGROUND

Asset management generally helps organizations manage their assets more effectively to achieve optimum possible performance. For example, many business organizations are taking managed print services (MPSs) from printer manufacturers and/or MPS providers to help manage their growing fleet of equipment and output devices such as copiers, printers, multi-function devices, and any other imaging device. This way, the MPS provider is responsible for maintaining and servicing the imaging devices, and for providing optimized solutions to meet customer needs.

One known practice for MPS is to manually survey/inspect a site location and provide optimized options for installation and distribution of imaging devices in the site location. In some cases, floor plans are received from the customer and proposed number and locations of imaging devices are supplied using the floor plan. Typically, the type, number, and distribution of the imaging devices is determined by the number of expected users in particular regions of the site location, imaging needs of the users, topography, and accessibility constraints, among others. Once approved, imaging devices are installed in the site location.

The initial installation may provide an “ideal” imaging environment for the organizational structure at the time of installation where load density is relatively optimized and balanced. However, reorganizational changes in business organizations are not uncommon. In most cases, these changes result to relocation, removal, or addition of personnel which often leads to changes in user density for a given imaging region if imaging devices remain in their respective installation points. In other cases, imaging devices are relocated, swapped out for different other imaging devices, upgraded, or discontinued due to changes in needs of particular users or structural modifications in the site. With any combination of these changes, optimization of the load density in the imaging environment may be compromised and become unbalanced as some imaging devices may become overloaded with jobs while others may become underutilized. Excessive use of an imaging device gradually impairs components and shortens the useful life of the imaging device. Meanwhile, customers have vested interest in maximizing imaging device use, which in turn means that underutilization of an imaging device is generally a waste of investment.

Common practice to overcome this unbalanced/unoptimized state is to re-inspect the site and provide new options for installation and imaging device deployment by manual means. This typically requires MPS providers to receive notifications regarding the changes for them to be able to dispatch service personnel to accomplish the task. However, business organizations often tend to neglect or overlook the effects of modifying the imaging environment and, as a result, often fail to provide notifications and/or request for re-optimizations. Further, a major impediment to immediate correction is the time it takes to manually perform the re-inspection which is a relatively long process. This introduces hidden cost of time wasted when the imaging environment is awaiting re-optimization.

What is needed is an application that can be readily used to inspect and/or examine load density in an imaging environment and perform optimization when necessary. What is also needed is a tool to allow users to easily obtain an optimized map and implement immediate corrective actions to curb the undesirable effects of changes in the imaging environment. Additional benefits and alternatives are also sought when devising solutions.

### SUMMARY

The above-mentioned and other problems become solved by methods for optimizing load density in a managed asset environment, such as in an imaging environment. In a representative embodiment, an environment includes a plurality of electronic devices, such as imaging devices, in a plurality of regions that subdivide the environment. Using an optimization application hosted by a computing device, usage information associated with electronic devices per region is generated. Based on the usage information, a determination is made whether load density per region exceeds a value of a predetermined metric. Upon determining that load density of at least one region exceeds the value, the application provides an indication to adjust a number of electronic devices in one or more of the regions to cause the load density of the at least one region to be less than the value and thereby substantially balance the load density between the plurality of regions. In an example aspect, the indication is provided as an optimized map reflecting changes and/or adjustments in electronic devices and their locations in the environment.

Other example embodiments contemplate augmenting the number of electronic devices in the at least one region by adding a new electronic device in the at least one region. The new electronic device can either be a relocatable underloaded electronic device in the environment or a fresh electronic device. The new electronic device is positioned proximate an overloaded electronic device in the at least one region in order to allow altering of its load to be below a predetermined threshold. Relocatable underloaded electronic devices that are not relocated become subjects for removal from the environment to do away with redundancy and/or underutilization of assets.

Further example embodiments note techniques for allowing users to manually adjust location of an added electronic device. The application displays on a map an initial location of the electronic device. Users adjust the initial location to a desired location on the map using an input device or a hand gesture on a display surface displaying the map to note a desired location.

These and other embodiments are set forth in the description below. Their advantages and features will become readily apparent to skilled artisans. The claims set forth particular limitations.

### BRIEF DESCRIPTION OF THE DRAWINGS

The accompanying drawings incorporated in and forming a part of the specification, illustrate several aspects of the present invention, and together with the description serve to explain the principles of the invention. In the drawings:

FIG. 1 is a diagrammatic view of a computing system including a network, a computing device, and an imaging environment having a plurality of imaging devices;

FIG. 2 is a diagrammatic view of the imaging environment subdivided into a plurality of regions;

FIG. 3 is a flowchart of actions for optimizing the imaging environment;

FIG. 4 is a flowchart illustrating an example method of categorizing underloaded imaging devices according to movability within the imaging environment;

FIG. 5 is a flowchart illustrating an example method of determining a way in which to add an imaging device proximate an overloaded imaging device;

FIG. 6 is a diagrammatic view for relocating an underloaded imaging device proximate to an overloaded imaging device within the same region;

FIG. 7 is a diagrammatic view for relocating an underloaded imaging device from a different region into a region of an overloaded imaging device;

FIG. 8 is a diagrammatic view for adding an imaging device proximate an overloaded imaging device in its region;

FIG. 9 is a diagrammatic view for adding an imaging device proximate multiple overloaded imaging devices in a given region;

FIG. 10 is a diagrammatic view of an optimized map; and

FIG. 11 is a diagrammatic view showing an initial location of an imaging device proximate an overloaded imaging device and a new location of the imaging device as adjusted by a user.

### DETAILED DESCRIPTION OF THE ILLUSTRATED EMBODIMENTS

In the following detailed description, reference is made to the accompanying drawings where like numerals represent like details. The embodiments are described in sufficient detail to enable those skilled in the art to practice the invention. It is to be understood that other embodiments may be utilized and that changes may be made without departing from the scope of the invention. The following detailed description, therefore, is not to be taken in a limiting sense and the scope of the invention is defined only by the appended claims and their equivalents. In accordance with the features of the invention, methods are described for optimizing load density in an imaging environment.

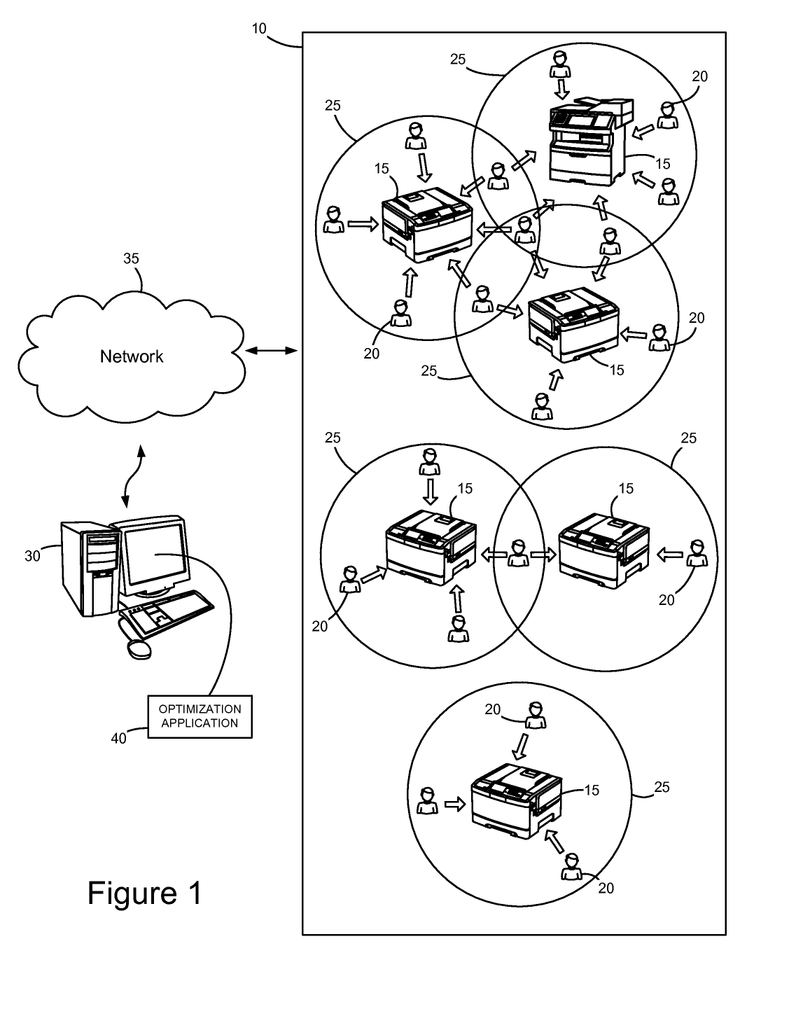

With reference to FIG. 1, an example imaging environment 10 established in a customer location is shown having a plurality of imaging devices 15. The imaging devices 15 are deployed variously in the customer location to accommodate a number of users 20. An imaging device 15 installed at a particular location can have a type that depends upon the number of surrounding users 20 and their specific needs. Example types include a mono imaging device, a colored imaging device, or a multi-function printer (MFP) employing laser, inkjet technology, dot matrix, or other printing technologies. Using imaging devices 15, users 20 can perform a variety of imaging functions such as scan, print, copy, fax, etc, depending on imaging device type. Further, in the example shown, coverage areas 25 represented by circles are defined for each imaging device 15 to characterize accessibility to users 20. Relatively close imaging devices can have overlapping coverage areas 25 to allow sharing of jobs and print loads from a large group of users, while others are deployed to be readily accessible to a few or an isolated group. In one example, the scope of the coverage areas may depend upon an imaging device's type, load capacity, and available functionalities, and/or represented by other shapes.

Imaging devices 15 in the imaging environment 10 and a computing device 30 are connected to a network 35 through associated interface devices, such as network interface cards (NICs). Although shown as a desktop computer, computing device 30 can be any other computing device including a laptop computer, a mobile device, etc. Network 35 implements any of a number of network topologies and includes a variety of software systems and hardware components such as routers, access points, switches, servers, etc. Electronic communication between devices connected to network 35 operates using wired or wireless connections, such as for example, using Ethernet UTP or fiber optic cables, or a wireless networking standard, such as IEEE 802.XX.

Computing device 30 makes available an optimization application 40 that users can utilize to determine a condition of the imaging environment 10 and implement corrections thereto for optimization, as needed. In particular, the optimization application 40 retrieves usage information associated with imaging devices 15, analyzes print load density in the imaging environment 10, and provides adjustment solutions to improve print load balance among imaging devices in the imaging environment 10. Solutions include arrangement modifications and/or device headcount adjustments including augmentation and reduction to address overloading and underutilization problems, as will be described in greater detail below.

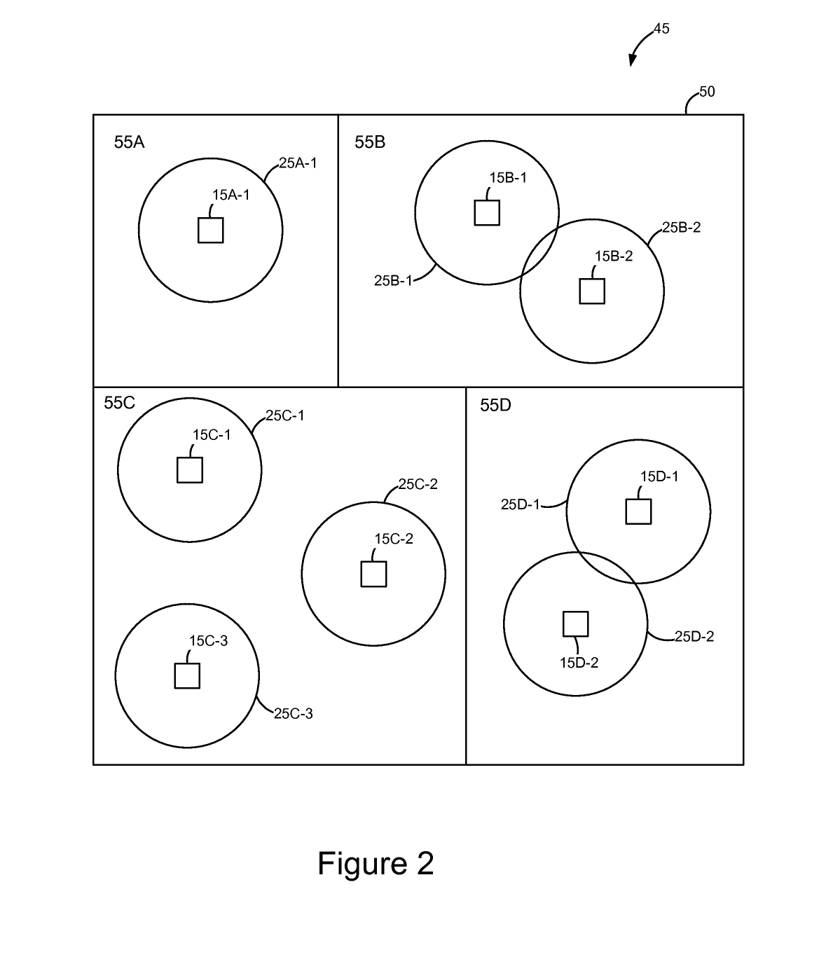

With reference to FIG. 2, positions of imaging devices 15 are plotted on a map 45 corresponding to a deployment area of the imaging devices 15. Also depicted are coverage areas 25 of each imaging device 15 in the map 45. In this example, map 45 contemplates a floor plan 50 of a building where the imaging devices are deployed. To obtain the relative locations of the imaging devices 15 on floor plan 50, the optimization application 40 may invoke the functionality of a location-based service from an asset management system (not shown), or any other remote computing system, for localizing the imaging devices 15. In an example aspect, floor plan 50 is calibrated with a coordinate system so that relative locations of imaging devices 15 are defined by coordinates.

Map 45 is subdivided into predetermined regions 55. Regions 55 are manually determined by service personnel to conform with the topography of floor plan 50 and/or localization of users in the environment 10. As such, although shown as having rectangular shapes, regions can have other shapes, whether regular or irregular, depending on floor plan topography. The floor plan 50 is calibrated with the regions 55 so that each imaging device 15 falls into one of the regions 55.

In general operation, the optimization application 40 analyzes the imaging environment 10 such as by determining print load density per region 55. Using a predetermined metric, it then determines whether print load density of at least one region 55 has exceeded a particular value. Thereafter, it provides indications via a display to adjust the number of imaging devices in the imaging environment 10 by adding, removing, and/or relocating imaging devices in the regions 55 to improve load balancing between regions. In an example aspect, these indications are provided using floor plan 50. Service personnel, technicians, and/or users themselves may then execute the adjustments to complete the optimization by following imaging device arrangements shown on the map. The optimization can be utilized as needed, such as in a regular manner or when organizational changes occur, to ensure that the imaging environment is in an optimized state.

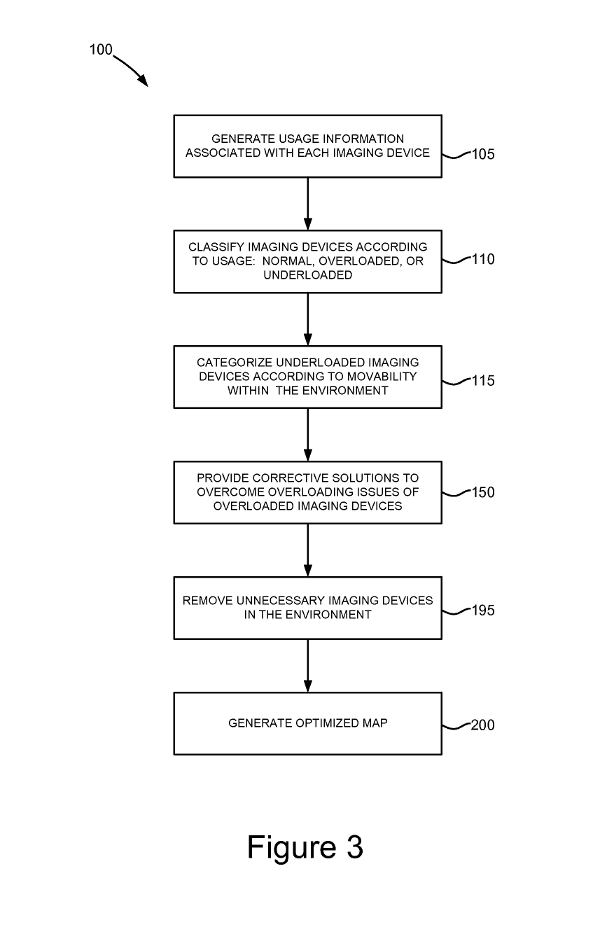

With reference to FIG. 3, a routine 100 for optimizing an imaging environment will now be described in more detail by way of example. In order to perform optimization, usage information associated with each imaging device 15 in the imaging environment 10 is generated at 105. Usage information includes any of a variety but, for purposes of illustration, is described herein as comprising page count data from print jobs. More particularly, each imaging device 15 keeps a record of the number of pages it has printed, and the application obtains page count information for each imaging device via network 35 for use in the optimization.

Once obtained, each imaging device is classified as one of “overloaded”, “underloaded”, and “normal” according to their associated page count information at 110. More particularly, an overloaded imaging device is classified as one having a print load that has exceeded a predetermined percentage of its expected monthly volume, such as greater than 90%. On the other hand, an underloaded imaging device exhibits a print load that is below a predetermined threshold, such as below 25% of its monthly volume. Meanwhile, a normal imaging device is characterized by a print load falling between the threshold limits defined for overloaded and underloaded imaging devices. As will be appreciated, threshold values described herein are for purposes of illustration and thus should not be considered limiting.

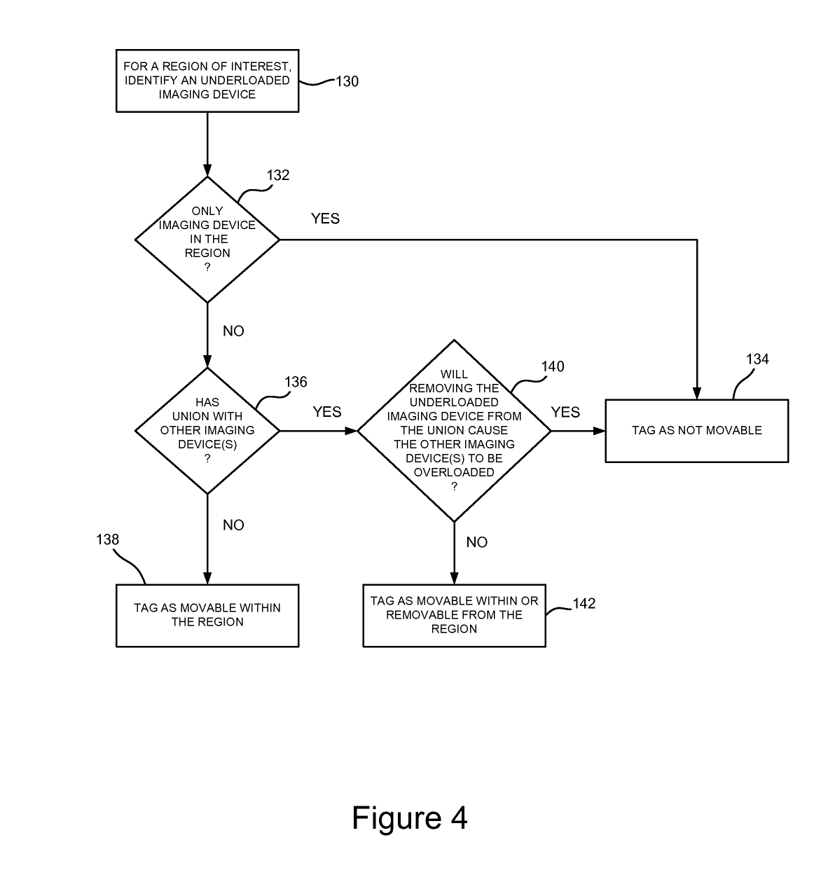

At 115, underloaded imaging devices for each region are tagged/categorized according to their movability within the environment 10. Categories include: (a) “not movable,” (b) “movable within its respective region,” or (c) “movable within and removable from its region.” These categories are generally used in future determinations on which underloaded imaging device to move from one location to another, or to discontinue use of, to achieve an optimized environment. FIG. 4 is a flowchart illustrating an example process of determining a category for an underloaded imaging device.

For a given region of interest, an underloaded imaging device is identified at 130. If the underloaded imaging device is determined to be the only imaging device in the region at 132, then such underloaded imaging device is tagged as “not movable” at 134. As an example, consider the imaging environment 10 depicted in FIG. 2. If the single imaging device 15A-1 in region 55A is underloaded, then it cannot be moved to allow users in the region to have continued imaging access.

Upon a negative determination at 132, a determination is made at 136 whether the underloaded imaging device has a union with other imaging device(s) in the region. In this example, union is established between imaging devices if their coverage areas overlap with each other, such as shown by imaging devices in regions 55B and 55D of FIG. 2. Meanwhile, arrangement of imaging devices 15 in region 55C shows otherwise. Coverage areas defined for each imaging device is predetermined and is dependent on a number of factors, as previously described. If the underloaded imaging device is determined to be not in union with other imaging device(s) in the region at 136, then it is tagged as being movable within its region at 138. For example, with further reference to FIG. 2, if any of the three imaging devices 15 in region 55C is underloaded, then they are tagged as being movable within region 55C.

However, if a union is determined to exist at 136, an analysis is performed on whether removing the underloaded imaging device from the union will cause the other imaging device(s) in the union to become overloaded at 140. If such is the case, then the underloaded imaging device is tagged as “not movable” at 134 so that load balance in the region/union will not be compromised. If not, the device is tagged as being movable within the region and further removable therefrom at 142. For example, in region 55B of FIG. 2, if imaging device 15B-1 is underloaded and, when removed from region 55B, will not cause imaging device 15B-2 to become overloaded, then imaging device 15B-1 can be tagged as being movable within region 55B and relocatable to any of the other regions 55A, 55C, and 55D. An example computation to ascertain a possible outcome load includes increasing load of the other imaging device by the underloaded imaging device's load (by page count), and determining if the increased load exceeds a threshold. For unions having more than two imaging devices, load (by page count) of the underloaded imaging device can be equally distributed among the remaining others, and outcome loads for each are then determined. Of course, other techniques can be used to determine outcome loads of the imaging devices.

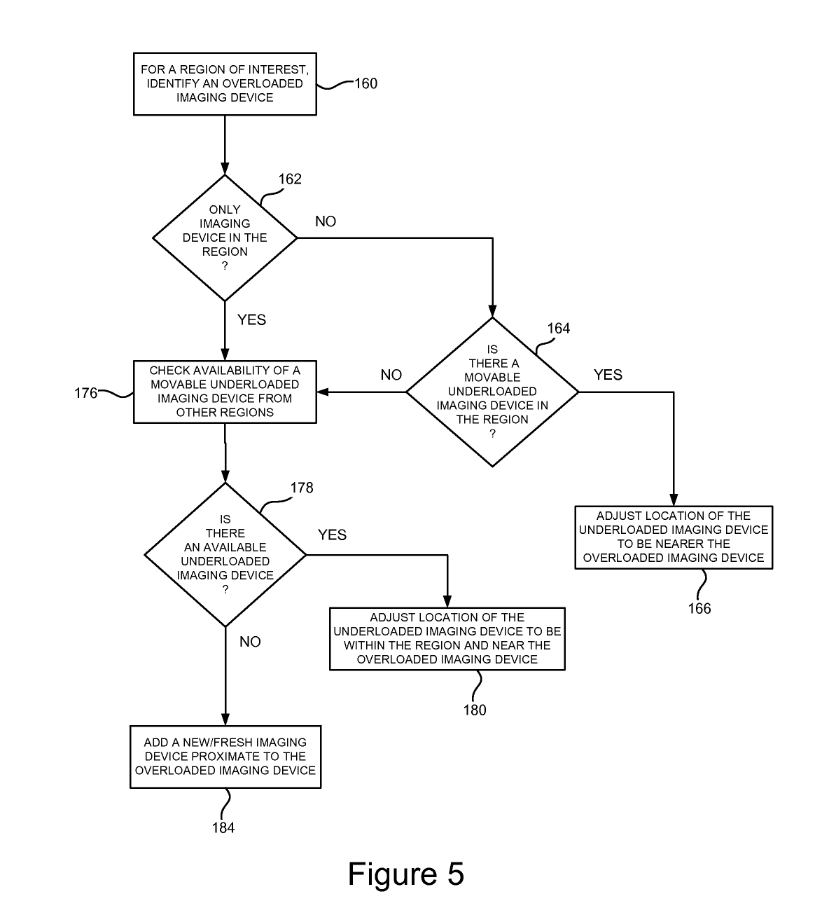

The foregoing described process of categorizing/tagging an underloaded imaging device is performed in an iterative fashion to account for each underloaded imaging device in the imaging environment 10. Once all underloaded imaging devices are accounted for at 115 (FIG. 3), process proceeds to 150 where each overloaded imaging device is provided with a corrective solution to overcome its overloading issue, namely, to add an imaging device relatively close to it, whether such imaging device is an underloaded imaging device existing in the imaging environment 10 or an imaging device that is entirely new therein. Generally, there are three possible actions: (1) move an underloaded imaging device within the region closer to the overloaded imaging device; (2) relocate an underloaded imaging device from another region into the overloaded imaging device's region and proximate thereto; and (3) add a fresh imaging device proximate the overloaded imaging device. Typically, actions (1) and (2) are selected if underloaded imaging devices are available for transfer. Otherwise, action (3) is selected. An available underloaded imaging device as described herein refers to one which has not been assigned or adjusted to a new location proximate an overloaded imaging device. FIG. 5 is a flowchart illustrating an example process of determining the way in which to add an imaging device proximate an overloaded imaging device.

At 160, an overloaded imaging device is identified for a given region of interest. At 162, if it is determined that the overloaded imaging device is not the only imaging device in the region, then the application checks an availability of an underloaded imaging device that is movable within the same region at 164. If there is one available, then the application adjusts the location of the underloaded imaging device to a more proximate location relative to the overloaded imaging device at 166, such as at a point on the floor plan 50 where the underloaded imaging device's coverage area overlaps with that of the overloaded imaging device. In instances where there are more than one available underloaded imaging device in the region, the device with the least minimal load can be selected. Alternatively, the closest one can be selected. As will be appreciated, other bases for selection can be used.

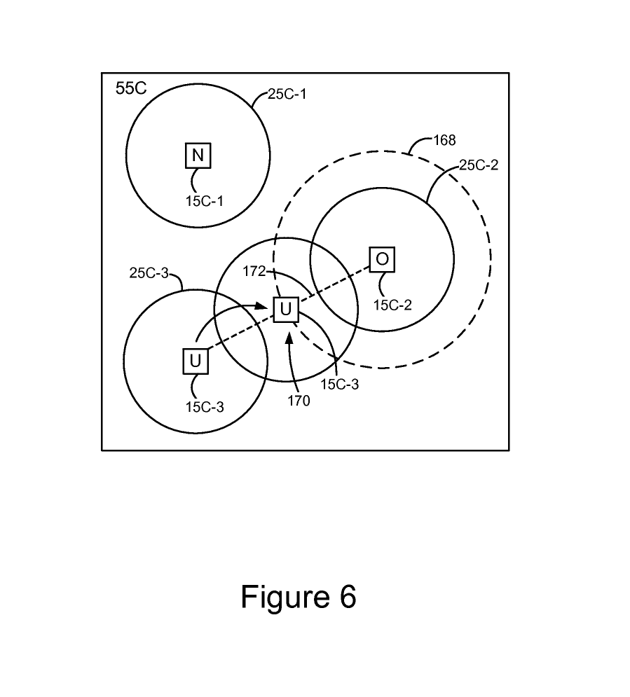

To illustrate the adjustment, consider FIG. 6 showing the imaging devices 15C-1, 15C-2, and 15C-3 in region 55C classified as normal (N), overloaded (O), and underloaded (U), respectively. Further shown is a transfer zone 168 that shrouds the coverage area 25C-2 of imaging device 15C-2. Transfer zone 168 defines an area within which an imaging device can be positioned to establish union with imaging device 15C-2 and thus allow altering of the print load thereof. In this example, transfer zone 168 is contemplated as having a radius that is greater than a radius of the coverage area 25C-2, and/or less than the sum of the radii of the coverage areas of imaging devices 15C-2, 15C-3 to be unioned. Generally, underloaded imaging device 15C-3 can be positioned anywhere within or at the perimeter of transfer zone 168. In some example cases, it may be desirable to move underloaded imaging device 15C-3 the least amount of distance closer to overloaded imaging device 15C-2 so as not to greatly affect users from its original location. Accordingly, an example approach shown in FIG. 6 includes selecting a location 170 on the floor plan 50 where the circumference of transfer zone 168 intersects with a line segment 172 connecting imaging devices 15C-2 and 15C-3 as the new location for the underloaded imaging device 15C-3. As will be appreciated, though, other techniques and algorithms to select a new location in transfer zone 168 or elsewhere around the overloaded imaging device can be utilized.

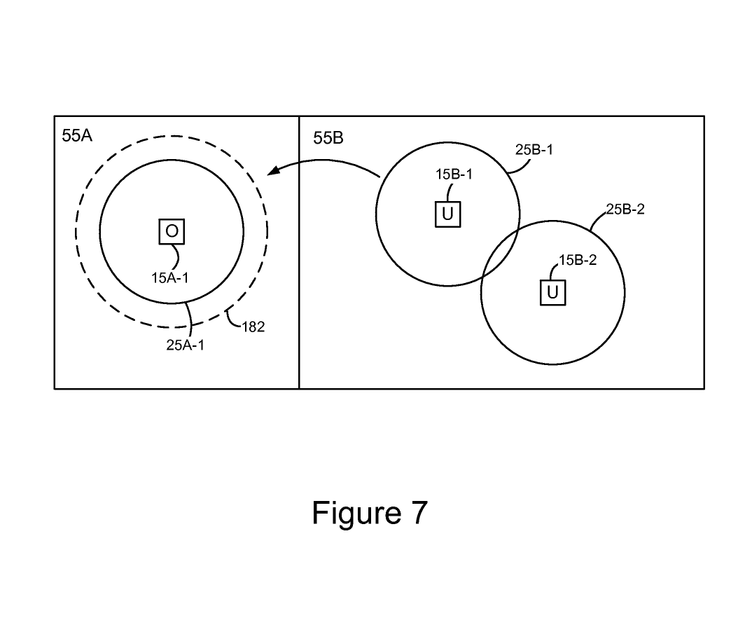

If no available underloaded imaging device in the region is determined at 164, the application looks for an available underloaded imaging device in other regions at 176. It is further noted that the same procedure at 176 is performed if, at 162, the overloaded imaging device is determined to be the only imaging device in its region. More particularly, the application finds available underloaded imaging devices tagged as being removable from their respective regions as determined in prior steps (142 in FIG. 4). If one is determined to exist at 178, then the application relocates such underloaded imaging device into the region of the overloaded imaging device and proximate thereto at 180 so that their coverage areas overlap. As an example illustration, FIG. 7 shows region 55A having its single imaging device 15A-1 classified as overloaded (O), and adjacent region 55B having its two imaging devices 15B-1, 15B-2 classified as underloaded (U) and establishing a union. If imaging device 15B-1 is previously determined to be removable from region 55B and available for transfer, then it is relocated into transfer zone 182 of overloaded imaging device 15A-1 in region 55A. In cases where there are multiple available underloaded imaging devices in the other regions, selection may be based on which one has a least minimal load, is closest relative to the transfer zone, or others. Different techniques in which to select a position of the underloaded imaging device in transfer zone 182 may be applied, including those described with respect to FIG. 6.

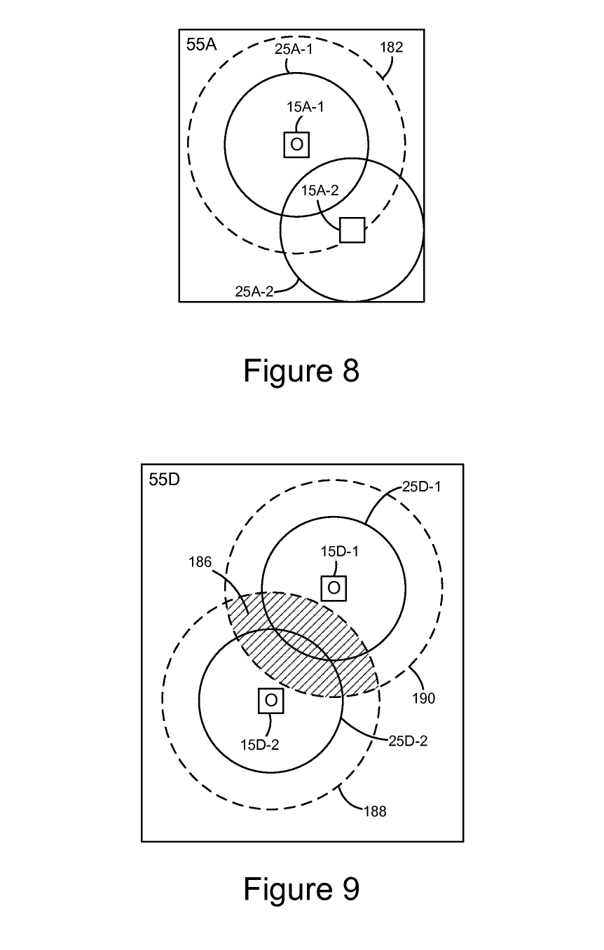

If there is no available underloaded imaging device determined at 178, then the application adds a new/fresh imaging device proximate the overloaded imaging device at 184. For example, in FIG. 8, transfer zone 182 is defined for overloaded (O) imaging device 15A-1 in region 55A and a new imaging device 15A-2 is located within region 55A and transfer zone 182 such that its coverage area 25A-2 overlaps with coverage area 25A-1 of overloaded imaging device 15A-1. Typically, location of the new imaging device in transfer zone 182 corresponds to an optimal point in which the imaging device 15A-2, when positioned at that optimal point, establishes sufficient area of union with the overloaded imaging device 15A-1 to allow substantial altering of the print load thereof. As an example, white space areas corresponding to areas on the region unoccupied by the coverage area of the overloaded imaging device are determined, and the optimal point in the transfer zone is selected as one which allows the coverage area of the added imaging device to cover as much white space areas on the region while at the same time establishing sufficient area of union (e.g., area of overlap is greater than or equal to a predetermined value) with the overloaded imaging device's coverage area. As will be appreciated, any variety of processing techniques can be used to determine an optimal point proximate an overloaded imaging device.

The foregoing process is performed iteratively to account for each overloaded imaging device in the imaging environment 10. For overlapping overloaded imaging devices such as shown in FIG. 9, an added imaging device (whether relocated or fresh) can be positioned in the overlap region 186 of the transfer zones 188, 190 of overloaded (O) imaging devices 15D-1, 15D-2, respectively, such as at circumferential intersection points of the transfer zones 188, 190 or coverage areas 25D-1, 25D-2, center of overlap region 186, or elsewhere therein.

After all overloaded imaging devices are accounted for, each remaining underloaded imaging device that was previously identified as being removable from its respective region (142 in FIG. 4) but have not been a subject for relocation either within its own region or into other surrounding regions (166 and 180 in FIG. 5), is identified as removable from the imaging environment 10 at 195 (FIG. 3). This advantageously corrects any redundancy and/or underutilization of an imaging device in the imaging environment.

Meanwhile, relative locations of imaging devices classified as having normal loads are maintained. In other example embodiments, a normally loaded imaging device can be identified with a “nearly overloaded” status if it is characterized by a print load that is within a predetermined range relatively close to the threshold limit defined for overloaded imaging devices. This way, the possibility of an imaging device becoming overloaded may be determined in advance and preemptive measures can be taken.

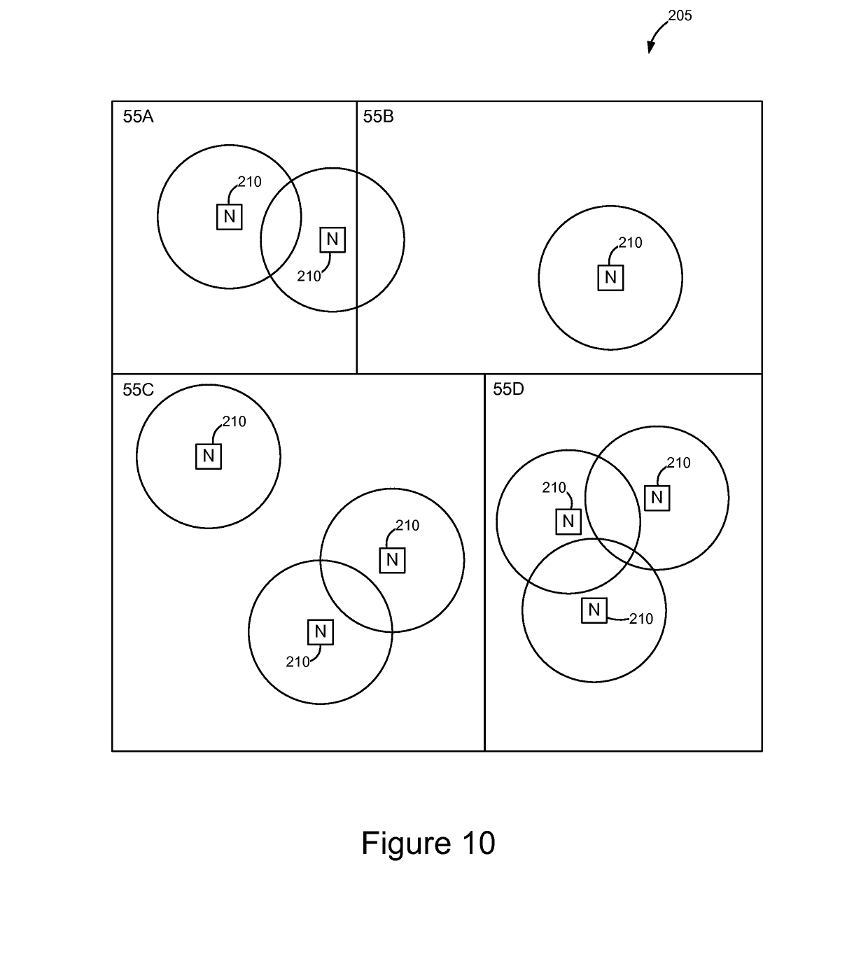

Thereafter, at 200, the application generates an optimized map as output indicating the adjustments including relocation, addition, and/or reduction of imaging devices. In FIG. 10, for example, an optimized map 205 shows imaging devices 210 in the environment, each of which having a normal (N) load after optimization. In an example aspect, relative locations of the adjusted imaging devices are noted by designators such as flags, stars, etc. placed on the optimized map. In another example aspect, different designators are used for noting each type of adjustment/status (relocated, newly added, removable, or nearly overloaded). In still other example aspects, information associated with a relocated imaging device is provided to allow attending users to easily locate them. This includes, but is not limited to, an imaging device's unique identification number, model name, type, initial location prior to the adjustment, etc.

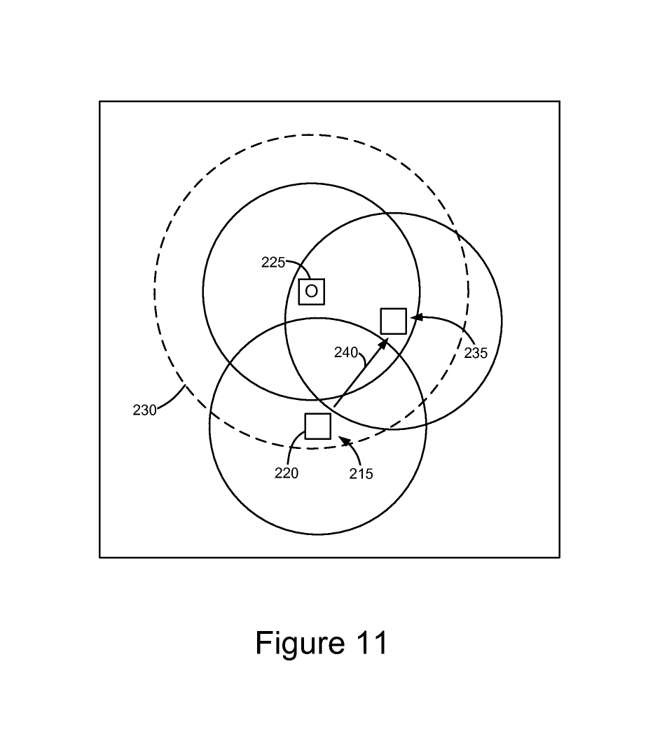

Appreciating that a determined new location may not be a suitable location at which to position an imaging device, such as due to the location corresponding to a wall, post, an immovable structure, or an uncrowded area, for instance, other example embodiments contemplate allowing users to manually select the new location. In particular, instead of automatically assigning a new location for an imaging device in a transfer zone, the application displays floor plan 50 showing a transfer zone associated within an overloaded imaging device and a suggested new location therein. The user then determines whether the suggested new location is properly applicable or not. If not, the user can adjust the imaging device location to a more proper location on floor plan 50 elsewhere in the transfer zone. In one example, users can do this by using an input device, such as a mouse, and applying an action such as a click, double-click, drag-and-drop, etc. to note a desired location. In other examples, users can apply a hand gesture on the display surface displaying floor plan 50 such as a tap, double-tap, swipe, drag-and-drop, or any other form recognizable by the application. In FIG. 11, for example, an initial location 215 for an added imaging device 220 is provided proximate on overloaded imaging device 225 within a transfer zone 230, and the user adjusts the imaging device 220 to a different location 235 by applying a hand gesture 240. When satisfied with the adjustment, the user can confirm the location by pressing a confirmation button (not shown).

In other embodiments, users can be provided with different options to choose from, such as options corresponding to aforementioned actions (1), (2), and/or (3). In addition or in the alternative, users can be provided with a selection of all available underloaded imaging devices and allowed to select which one to transfer. The application can repeatedly present all possible options until the user selects one. Once an option for a particular overloaded imaging device is confirmed, the process will proceed with the next overloaded imaging device and repeat required process steps until all overloaded imaging devices are accounted for. It is further noted that once an underloaded imaging device has been confirmed by the user for transfer near an overloaded imaging device, it can be tagged as “unavailable” for transfer and thus can no longer be used as a candidate for transfer when analyzing subsequent overloaded imaging devices.

The application of the present invention also goes beyond use of page count information for optimization. For example, optimization may further take into account print job features such as simplex/duplex, print quality, color output (monochrome or colored), print job content (e.g., text, graphic, or photo), etc., or other usage information associated with other functions of an imaging device, such as scanning, e-mailing, faxing, etc. Additionally, although example embodiments have been described using imaging devices, it will be appreciated that the methods described herein are further applicable in optimizing a variety of computing system or managed asset environments employing different types of electronic devices, apparatuses, or equipment.

The foregoing illustrates various aspects of the invention. It is not intended to be exhaustive. Rather, it is chosen to provide the best illustration of the principles of the invention and its practical application to enable one of ordinary skill in the art to utilize the invention, including its various modifications that naturally follow. All modifications and variations are contemplated within the scope of the invention as determined by the appended claims. Relatively apparent modifications include combining one or more features of various embodiments with features of other embodiments.

1. A method for optimizing load density in an environment having a plurality of electronic devices in a plurality of regions that subdivide the environment, comprising:
generating usage information associated with electronic devices per region;
based on the usage information, determining whether load density per region exceeds a value of a predetermined metric; and
upon determining that a load density of at least one region exceeds the value, providing an indication to adjust a number of electronic devices in one or more of the regions to cause the load density of the at least one region to be less than the value and thereby substantially balance the load density between the plurality of regions.

2. The method of claim 1, wherein the providing the indication to adjust the number of electronic devices includes providing an indication to augment the number of electronic devices in the at least one region by adding a new electronic device in the at least one region.

3. The method of claim 2, wherein the adding the new electronic device in the at least one region includes relocating at least one other electronic device from regions other than the at least one region into the at least one region.

4. The method of claim 1, further comprising:
for each of the at least one region, determining an overloaded electronic device having a load that has exceeded a predetermined threshold; and
providing an indication to add a new electronic device proximate the overloaded electronic device so as to allow altering of the load thereof to be below the predetermined threshold.

5. The method of claim 4, wherein the providing the indication to add the new electronic device includes defining a transfer zone surrounding the overloaded electronic device within which the new electronic device can be positioned.

6. The method of claim 1, further comprising:
determining one or more underloaded electronic devices of the plurality of electronic devices having a load that is below a predetermined threshold;
wherein the providing the indication to adjust the number of electronic devices includes providing an indication to relocate the one or more underloaded electronic devices into the at least one region.

7. The method of claim 1, wherein the providing the indication to adjust the number of electronic devices includes generating a map of the environment indicating a zone within each of the at least one region that defines an area within which another electronic device can be positioned.

8. A method for optimizing load density in an environment having a plurality of electronic devices, comprising:
calibrating a map of the environment with locations of the plurality of electronic devices;
receiving usage information associated with each electronic device of the plurality of electronic devices;
based upon the usage information, determining an overloaded electronic device of the plurality of electronic devices having a load that exceeds a predetermined threshold; and
indicating a zone in the map that defines an area within which another electronic device can be positioned proximate the overloaded electronic device to allow altering of the load thereof to be below the predetermined threshold.

9. The method of claim 8, further comprising defining the area of the zone such that when the another electronic device is positioned within the zone, a first coverage area of the another electronic device at least overlaps with a second coverage area of the overloaded electronic device.

10. The method of claim 8, further comprising:
based upon the usage information, determining an underloaded electronic device of the plurality of electronic devices having a load that is below a second predetermined threshold; and
providing an indication that the underloaded electronic device can be relocated within the zone proximate the overloaded electronic device.

11. The method of claim 10, wherein the determining the underloaded electronic device includes determining that a first coverage area thereof overlaps within a second coverage area of another underloaded electronic device of the plurality of electronic devices.

12. The method of claim 8, further comprising:
subdividing the map into a number of regions, each region including one or more of the plurality of electronic devices;
based upon the usage information, determining an underloaded electronic device having a load that is below a second predetermined threshold within a region including the overloaded electronic device; and
providing an indication that the underloaded electronic device is movable within the region and into the zone.

13. The method of claim 8, further comprising:
subdividing the map into a number of regions each including one or more of the plurality of electronic devices, the overloaded electronic device being in a first region; and
providing an indication to adjust a number of electronic devices in the first region.

14. The method of claim 13, wherein the providing the indication to adjust the number of electronic devices in the first region includes providing an indication to augment the number of electronic devices in the first region by relocating an underloaded electronic device of the plurality of electronic devices from a second region outside the first region into the zone within the first region.

15. A method for optimizing load density in an environment having a plurality of electronic devices, comprising:
receiving usage information associated with each electronic device of the plurality of electronic devices;
based upon the usage information, identifying at least one underloaded electronic device of the plurality of electronic devices having a load that is below a predetermined threshold;
upon identifying an underloaded electronic device, determining whether a coverage area of the underloaded electronic device overlaps with another coverage area of another underloaded electronic device; and
upon a positive determination, providing an indication that the underloaded electronic device is movable from a location thereof in the environment.

16. The method of claim 15, further comprising, upon a negative determination, providing an indication that the underloaded electronic device is not movable from the location thereof in the environment.

17. The method of claim 15, further comprising:
calibrating a map of the environment with locations of the plurality of electronic devices; and
indicating a zone in the map associated with an overloaded electronic device having a second load above a second predetermined threshold, the zone defining an area within which the underloaded electronic device can be moved proximate the overloaded electronic device to allow altering of the second load thereof to be below the second predetermined threshold.

18. The method of claim 17, further comprising:
subdividing the map into a number of regions each including one or more of the plurality of electronic devices, the underloaded electronic device being in a first region of the plurality of regions;
calculating a resulting load percentage of the first region if the underloaded electronic device is removed from the first region; and
if the calculated resulting load percentage is below a predetermined value, providing an indication that the underloaded electronic device is removable from the first region.

19. The method of claim 17, further comprising:
subdividing the map into a number of regions each including one or more of the plurality of electronic devices, the underloaded electronic device being in a first region of the plurality of regions; and
determining that the underloaded electronic device is not removable from the first region if the underloaded electronic device is the only electronic device within the first region.

20. The method of claim 15, further comprising defining corresponding coverage areas of the electronic devices based upon at least one of a type and load capacity thereof.
